(19) United States
(12) Patent Application Publication
(10) Pub. No.: US 2024/0401610 A1
(43) Pub. Date: Dec. 5, 2024

(54) STRUCTURAL E WATER PUMP

(71) Applicant: FCA US LLC, Auburn Hills, MI (US)

(72) Inventors: Mark A. Kamm, Rochester, MI (US); Jake E. Seeger, Berkley, MI (US)

(21) Appl. No.: 18/325,452

(22) Filed: May 30, 2023

(51) Int. Cl. F04D 29/62; F04D 1/00; F04D 29/42; H02K 7/10; H02K 7/18

(52) U.S. Cl. CPC F04D 29/628; F04D 1/00; F04D 29/426; H02K 7/1004; H02K 7/1815

(57) ABSTRACT

An automotive vehicle water pump has a housing with a cavity for receiving an impeller, motor and fluid and a fluid inlet and outlet. A first support on the housing secures the housing to an engine. A mounting boss is on the water pump housing. The mounting boss receives an alternator to mount the alternator with respect to the engine.

### FIELD

The present disclosure relates to automotive vehicles and, more particularly, to vehicles utilizing a structural water pump.

### BACKGROUND

This section provides background information related to the present disclosure which is not necessarily prior art.

In internal combustion engine automotive vehicles, the engine compartment is filled with various brackets to be attached to the engine to hang accessory drive components such as alternators, air conditioner compressors, or other components that need to be mounted in some fashion to the engine.

Engine compartments have become smaller and more compact. Thus, there is a lack of packaging space for adding brackets to the engine. Thus, packaging solutions are needed in order to provide mounting brackets for accessory drive components.

### SUMMARY

This section provides a general summary of the disclosure, and is not a comprehensive disclosure of its full scope or all of its features.

Thus, in accordance with the present disclosure, utilization of the water pump housing to provide a mounting bracket for an accessory drive component reduces the packaging space. Also, this saved an additional component and provided support for the accessory drive component, in this case, an alternator. Thus, the present disclosure provided a reduced costs for material cost and labor since an additional bracket is not needed. Additionally, no changes are needed to the cylinder block to provide packaging space for a separated alternator bracket.

According to the present disclosure, an automotive vehicle water pump comprises a housing that includes a cavity to receive an impeller, motor and fluid. The housing includes a fluid inlet and outlet. A first support is on the housing to secure the housing to an engine. A mounting bracket is on the housing to receive an accessory drive component, such as an alternator, to mount the accessory drive component with respect to the engine. The housing includes a water pump cover portion and a pump body portion. The mounting bracket includes a boss to support the accessory drive component, such as an alternator. The mounting bracket includes a bore to receive a fastener to secure the accessory drive component. The pump cover portion includes the mounting bracket and the water pump body portion includes the support. The mounting bracket includes a support to receive a clevis of the accessory drive component, here the alternator.

According to a second aspect of the disclosure, an automotive vehicle has an engine including a water pump and an alternator that comprise a housing that includes a cavity to receive an impeller, motor and fluid. The housing includes a fluid inlet and outlet. A first support is on the housing to secure the housing to an engine. A mounting bracket is on the housing to receive an accessory drive component, such as an alternator, to mount the accessory drive component with respect to the engine. The housing includes a water pump cover portion and a pump body portion. The mounting bracket includes a boss to support the accessory drive component, such as an alternator. The mounting bracket includes a bore to receive a fastener to secure the accessory drive component. The pump cover portion includes the mounting bracket and the water pump body portion includes the support. The mounting bracket includes a support to receive a clevis of the accessory drive component, here the alternator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a side elevation schematic view of an engine including the water pump housing.

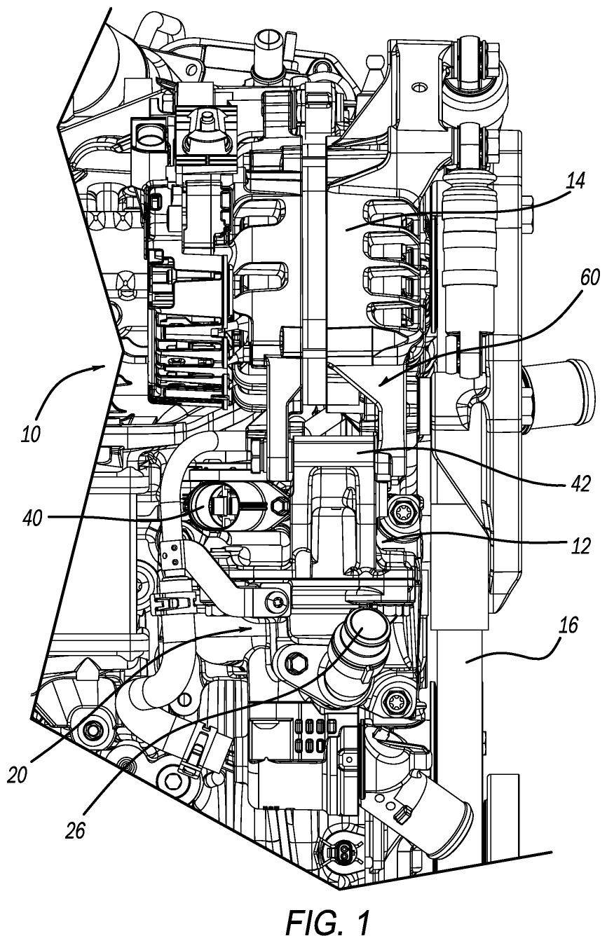

FIG. 2 is a front plan schematic view of the engine with the water pump.

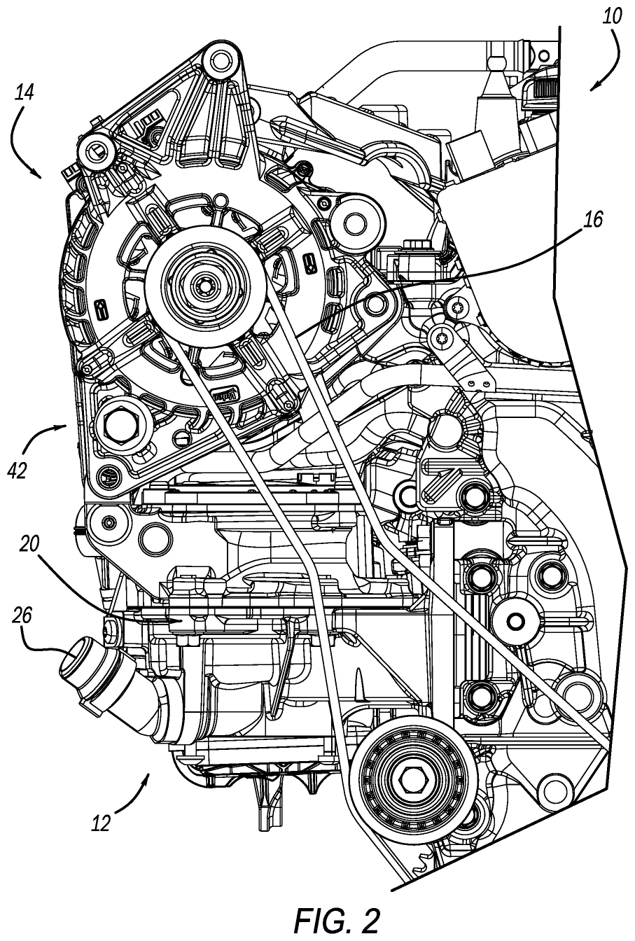

FIG. 3 is a rear schematic plan view of the water pump.

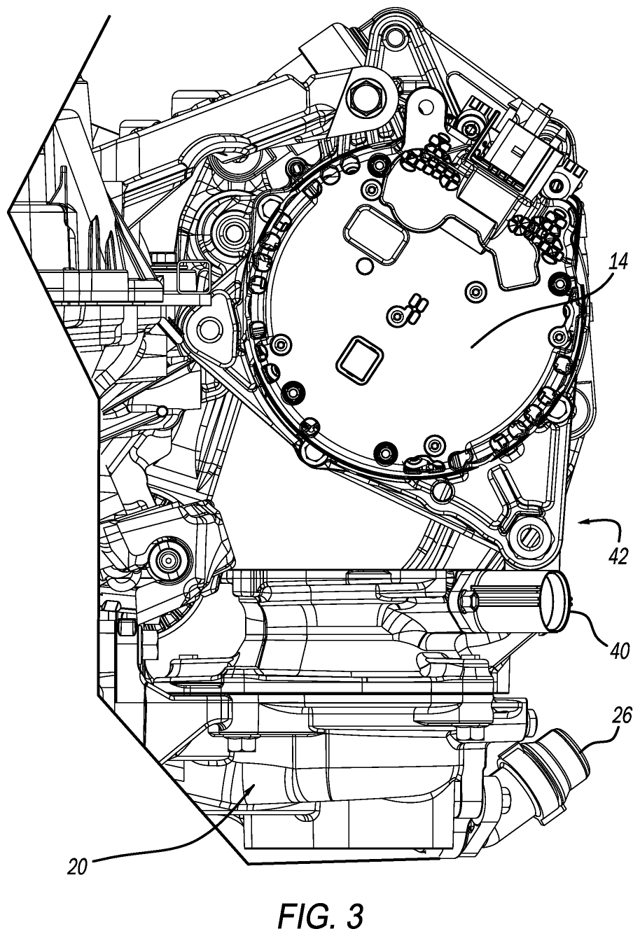

FIG. 4 is a perspective view of the water pump housing with an accessory drive component.

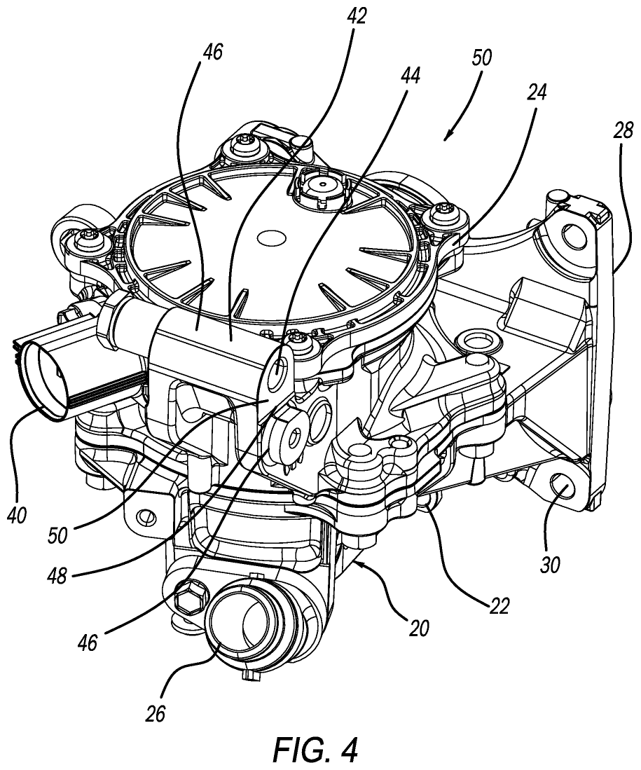

FIG. 5 is a schematic view of the water pump housing.

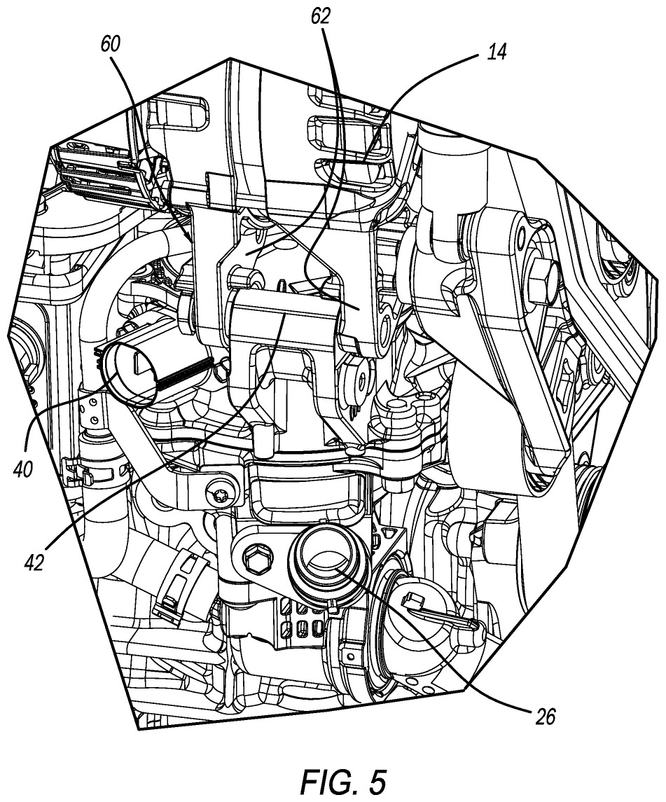

Corresponding reference numerals indicate corresponding parts throughout the several views of the drawings.

### DETAILED DESCRIPTION

Example embodiments will now be described more fully with reference to the accompanying drawings.

Turning to the figures, an engine is illustrated and designated with the reference numeral 10. The engine includes a water pump 12 and an accessory drive component such as an alternator 14. A belt 16 connects to the alternator via a pulley 18 that drives the alternator.

The water pump 12 includes a housing 20. The housing 20 includes a water pump body 22 connected with a water pump cover 24. The water pump body 22 includes an inlet 26 and a support 28. The support 28 has an overall plate like structure and includes bores 30 that receives fasteners to secure the support 28 to the engine 10. The water pump housing 20 houses the impeller, motor and fluid cavity, not shown, to enable fluid to pass through the water pump 12 into the engine 10 and into other various components.

The water pump cover 24 includes the outlet 40 enabling fluid to exist the engine. Also, the water pump cover 24 includes a mounting boss 42. The mounting boss 42 is integrally formed with the water pump cover 24. The mounting boss 42 includes a bore 44 that extends through a support portion 46 of the mounting boss 42. The bore 44 receives a fastener that secures the alternator 14 with the mounting boss 42. The boss support portion 46 includes cutout portions 48 that enables bushings 48 of the accessory component to abut the face 50 of the boss support portion 46.

The alternator 14 includes a clevis 60 having a pair of arms 62 that project from the alternator 14 and are spaced on the sides of the mounting boss 42. The bolt is passed through the clevis arms 62 into the bore to secure the alternator 14 with the mounting boss 42 integrally formed on the water pump cover 24. Thus, this significantly reduces the complexity of mounting the alternator and provides a compact packaging solution. Thus, by including the mounting boss 42 on the water pump cover 24, this resolves a space and mounting issue of the alternator 14 as well as reduces the weight and eliminates an extra component. Thus, material cost and labor to install the alternator is reduced.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automotive vehicle water pump comprising:
a housing including a cavity for receiving an impeller, motor and fluid and a fluid inlet and outlet;
a first support on the housing for securing the housing to an engine; and
a mounting boss on the housing, the mounting boss for receiving an accessory drive component to mount the accessory drive component with respect to the engine.

2. The automotive vehicle water pump of claim 1, wherein the housing includes a water pump cover portion and a pump body portion.

3. The automotive vehicle water pump of claim 1, wherein the mounting boss supports the accessory drive component.

4. The automotive vehicle water pump of claim 1, wherein the mounting boss includes a bore for receiving a fastener for securing the accessory drive component.

5. The automotive vehicle water pump of claim 2, wherein the water pump cover portion includes the mounting boss.

6. The automotive vehicle water pump of claim 2, wherein the water pump body portion includes the support.

7. The automotive vehicle water pump of claim 1, wherein the mounting boss receives a clevis of the accessory drive component.

8. An automotive vehicle having an engine including a water pump and an alternator comprising:
a housing including a cavity for receiving an impeller, motor and fluid and a fluid inlet and outlet;
a first support on the housing for securing the housing to the engine; and
a mounting boss on the housing, the mounting boss for receiving the alternator to mount the alternator with respect to the engine.

9. The automotive vehicle of claim 8, wherein the housing includes a water pump cover portion and a pump body portion.

10. The automotive vehicle water pump of claim 8, wherein the mounting boss supports the alternator.

11. The automotive vehicle water pump of claim 8, wherein the mounting boss includes a bore for receiving a fastener for securing the alternator.

12. The automotive vehicle water pump of claim 9, wherein the water pump cover portion includes the mounting bosst.

13. The automotive vehicle water pump of claim 9, wherein the water pump body portion includes the support.

14. The automotive vehicle water pump of claim 8, wherein the mounting boss receives a clevis of the alternator.
